(19) United States
(12) Patent Application Publication
(10) Pub. No.: US 2012/0306797 A1
(43) Pub. Date: Dec. 6, 2012

(54) LIQUID-CRYSTAL DISPLAY DEVICE

(75) Inventor: Katsunori Misaki, Yonago-shi (JP)

(73) Assignee: SHARP KABUSHIKI KAISHA, Osaka-shi, Osaka (JP)

(21) Appl. No.: 13/576,037

(22) PCT Filed: Nov. 22, 2010
(86) PCT No.: PCT/JP2010/070829

§ 371 Date: Jul. 30, 2012

(30) Foreign Application Priority Data
Feb. 2, 2010 (JP) 2010-021441

(51) Int. Cl. G09G 3/36; G06F 3/041

(52) U.S. Cl. 345/173; 345/87

(57) ABSTRACT

A liquid crystal display device (100) includes: a touch panel (101); and a color filter substrate (102) having (i) a first surface which faces the touch panel (101) and (ii) a second surface which is opposite from the first surface and on which at least one black matrix (15) is provided, the touch panel (101) including an Al layer (13c) that has a light blocking property, and in order to block light which enters the color filter substrate (102) from the second surface side and then leaks from a vicinity of the at least one black matrix (15) toward the touch panel (101), the Al layer (13c) being provided on the touch panel (101) so that a part of the Al layer (13c) and a part of the at least one black matrix (15) overlap each other when the Al layer (13c) is seen from the touch panel (101) side.

### TECHNICAL FIELD

The present invention relates to a liquid crystal display device which is provided with a touch panel function.

### BACKGROUND ART

In recent years, a sophisticated liquid crystal display device has been provided in which convenience for a user has been enhanced by providing a liquid crystal display panel with a touch panel function as a function other than an information display function.

Specifically, a liquid crystal display device has been provided which includes a liquid crystal display panel and a touch panel. The liquid crystal display panel serves as a display section that displays information including a text and an image. The touch panel is provided on the display surface side of the liquid crystal display panel or on an opposite side from the display surface side.

Further, it is highly possible that a high-value added liquid crystal display device will be produced in which a liquid crystal display panel is provided with an in-cell capacitive touch panel (multi-touch). Furthermore, it is expected that such a liquid crystal display device can dramatically reduce man-hours and member costs thereof as compared to a conventional liquid crystal display device that is provided with a touch panel function.

As described earlier, it is considered that a liquid crystal display device which is provided with not only an information display function carried out by a liquid crystal display panel but also an operation input function carried out by a touch panel makes it possible to provide a user with various services such as an information display in accordance with an input of an instruction from the user.

In other words, a liquid crystal display device has been arranged to display an operation input screen on a display surface of a liquid crystal display panel thereof and to cause a touch panel thereof to detect an operation input to the operation input screen from a user. Then, in accordance with a result of the detection, the liquid crystal display device changes the display surface from the operation input screen to a display screen that displays information desired by the user. The liquid crystal display device is thus arranged to be capable of displaying information desired by the user.

Meanwhile, a resin light blocking film called a black matrix is provided in the liquid crystal display panel so as to surround each pixel electrode. The liquid crystal display panel provided with the black matrix allows an edge of each pixel to be sharp and allows an improvement in contrast.

The black matrix is also provided in a region (panel peripheral part) which is located outside a region in which pixels of the liquid crystal display panel are provided, so as to prevent light leakage from occurring in the panel peripheral part.

For example, Patent Literature 1 discloses the following technique: A rim of a first black matrix that surrounds a display region is set on an inside of a frame-shaped sealing material provided in a rim of a substrate. Then, a second black matrix which is frame-shaped and is made of a light blocking material is formed on an outer surface of a front substrate along the frame-shaped sealing material.

However, if defects such as a pinhole and lack of a pattern occur in the second black matrix, a leakage of light from a backlight occurs in a part in which such defects occur. This may cause a deterioration in display quality.

Such a problem is directly applicable to a liquid crystal display panel provided with an in-cell touch panel (described above). This is because, even if the liquid crystal display panel is provided with the in-cell touch panel, the liquid crystal display panel part is identical to a conventional liquid crystal.

An example of a liquid crystal display panel provided with an in-cell touch panel is described below with reference to (a) and (b) of FIG. 14. Note that the following description refers to (i) a peripheral part in which no image is displayed as a panel peripheral part and (ii) a part in which an image is displayed as a panel pixel section.

(a) and (b) of FIG. 14 are cross-sectional views each showing a panel peripheral part of a conventional liquid crystal display device. As shown in (a) of FIG. 14, a liquid crystal display device 500 includes a touch panel layer (not shown), a color filter substrate 501, a liquid crystal layer 502, and a TFT substrate 503 in this order. Black matrixes 51 are provided on a surface of the color filter substrate 501 which surface faces the liquid crystal layer 502, and TFT wires 52 are provided on a surface of the TFT substrate 503 which surface faces the liquid crystal layer 502. Note that the TFT wires 52 are provided so as to fill a gap between the respective black matrixes 51.

Then, when a backlight enters the liquid crystal display device 500 from the TFT substrate 503 side, a part of the backlight passes through a gap between the respective TFT wires 52 (passing light 53). However, as described above, the TFT wires 52 are provided so as to fill the gap between the respective black matrixes 51. Therefore, the passing light 53 is interrupted by the black matrixes 51.

However, in a case where displacement occurs between the color filter substrate 501 and the TFT substrate 503, a part of the passing light 53 is transmitted through the color filter substrate 501 and the touch panel layer as it is without being interrupted by the black matrixes 51, so that light leakage occurs (see (b) of FIG. 14).

Next, another example of a liquid crystal display panel provided with an in-cell touch panel is described with reference to (a) and (b) of FIG. 15. (a) of FIG. 15 is a cross-sectional view of a panel pixel section of a conventional liquid crystal display device. As shown in (a) of FIG. 15, a liquid crystal display device 600 includes a touch panel layer (not shown), a color filter substrate 601, a liquid crystal layer 602, and a TFT substrate 603 in this order. Black matrixes 61 are provided on a surface of the color filter substrate 601 which surface faces the liquid crystal layer 602, and the TFT wires 62 are provided on a surface of the TFT substrate 603 which surface faces the liquid crystal layer 602.

(b) of FIG. 15 is an enlarged view of a region A in (a) of FIG. 15. Color filters 604a, 604b, and 604c subjected to an etching treatment are provided on the color filter substrate 601 with no gap therebetween (see (b) of FIG. 15). A counter electrode 63 is provided on the color filters 604a, 604b, and 604c. The color filters 604a, 604b, and 604c differ in color. The TFT wires 62 are covered with a protective film 605, and a pixel electrode 64 is provided on the protective film 605. An electric field for controlling a transmittance of the liquid crystal layer 602 is defined by the counter electrode 63 and the pixel electrode 64.

Note here that displacement in patterning carried out during the etching treatment causes (i) the color filters 604a and 604b to overlap each other and (ii) the color filters 604b and 604c to overlap each other on the black matrixes 61, and protrusions are provided in respective parts in which (i) the color filters 604a and 604b overlap each other and (ii) the color filters 604b and 604c overlap each other. This causes an abnormality in alignment of liquid crystal in vicinities of the respective protrusions.

This causes light to be unexpectedly transmitted through a region in which such an alignment abnormality as described above occurs. Then, passing light 65 is transmitted through the color filter substrate 601 and the touch panel layer as it is, so that light leakage occurs (see (a) of FIG. 15).

The light leakage described above causes a reduction in display contrast of the panel peripheral part and the panel pixel section. Particularly, the light leakage causes a dramatic deterioration in display quality in a case where a bright text and/or a graphic is displayed in a dark display surface.

### CITATION LIST

### Patent Literatures

Patent Literature 1
Japanese Patent Application Publication, Tokukai, No. 2007-304274 A (Publication Date: Nov. 22, 2007)

### SUMMARY OF INVENTION

### Technical Problem

The present invention has been in view of the problems, and an object of the present invention is to provide a liquid crystal display device that is capable of preventing a leakage of light from a backlight without fail.

### Solution to Problem

In order to attain the object, a liquid crystal display device in accordance with the present invention includes: a touch panel; and a color filter substrate having (i) a first surface which faces the touch panel and (ii) a second surface which is opposite from the first surface and on which at least one black matrix is provided, the touch panel including a light blocking member that has a light blocking property, and in order to block light which enters the color filter substrate from the second surface side and then leaks from a vicinity of the at least one black matrix toward the touch panel, the light blocking member being provided in the touch panel so that a part of the light blocking member and a part of the at least one black matrix overlap each other when the light blocking member is seen from the touch panel side.

According to the arrangement, the light blocking member is provided on the touch panel so that a part of the light blocking member and a part of the at least one black matrix overlap each other when the light blocking member is seen from the touch panel side. This makes it possible to block light which enters the color filter substrate and then leaks from a vicinity of the at least one black matrix toward the touch panel without being blocked by at least one the black matrix.

Consequently, even light which leaks from a vicinity of the at least one black matrix is blocked by the touch panel. This makes it possible to prevent light leakage from the touch panel.

### Advantageous Effects of Invention

As described above, the liquid crystal display device in accordance with the present invention includes: a touch panel; and a color filter substrate having (i) a first surface which faces the touch panel and (ii) a second surface which is opposite from the first surface and on which at least one black matrix is provided, the touch panel including a light blocking member that has a light blocking property, and in order to block light which enters the color filter substrate from the second surface side and then leaks from a vicinity of the at least one black matrix toward the touch panel, the light blocking member being provided in the touch panel so that a part of the light blocking member and a part of the at least one black matrix overlap each other when the light blocking member is seen from the touch panel side.

Therefore, even light which leaks from a vicinity of the at least one black matrix is blocked by the touch panel. This yields an effect of preventing light leakage from the touch panel.

### BRIEF DESCRIPTION OF DRAWINGS

FIG. 1

FIG. 1 shows how a liquid crystal display device in accordance with a first embodiment of the present invention causes a touch panel wire to prevent light leakage.

FIG. 2

(a) of FIG. 2 is a cross-sectional view of a panel pixel section of a liquid crystal display device shown in FIG. 1. (b) of FIG. 2 is a cross-sectional view of a panel peripheral part of the liquid crystal display device. (c) of FIG. 2 is a cross-sectional view of a vicinity of a touch panel terminal of the liquid crystal display device. (d) of FIG. 2 is a cross-sectional view of a panel terminal section of the liquid crystal display device.

FIG. 3

FIG. 3 is a plan view of the liquid crystal display device shown in FIG. 1.

FIG. 4

(a) of FIG. 4 is a cross-sectional view of a panel pixel section of a liquid crystal display device in accordance with a second embodiment of the present invention. (b) of FIG. 4 is a cross-sectional view of a panel peripheral part of the liquid crystal display device. (c) of FIG. 4 is a cross-sectional view of a vicinity of a touch panel terminal of the liquid crystal display device. (d) of FIG. 4 is a cross-sectional view of a panel terminal section of the liquid crystal display device.

FIG. 5

FIG. 5 is an enlarged view of a region A surrounded by a dotted line in (a) of FIG. 4.

FIG. 6

FIG. 6 is a plan view of the liquid crystal display device shown in each of (a) to (d) of FIG. 4.

FIG. 7

(a) of FIG. 7 is a cross-sectional view of a panel pixel section of a liquid crystal display device in accordance with a third embodiment of the present invention. (b) of FIG. 7 is a cross-sectional view of a panel peripheral part of the liquid crystal display device. (c) of FIG. 7 is a cross-sectional view of a vicinity of a touch panel terminal of the liquid crystal display device. (d) of FIG. 7 is a cross-sectional view of a panel terminal section of the liquid crystal display device.

FIG. 8

FIG. 8 is an enlarged view of a region A surrounded by a dotted line in (a) of FIG. 7.

FIG. 9

(a) of FIG. 9 is a plan view shows a part of a touch electrode shown in FIG. 7. (b) of FIG. 9 is an enlarged view of a region B surrounded by a dotted line in (a) of FIG. 9.

FIG. 10

FIG. 10 is a plan view of the liquid crystal display device shown in each of (a) to (d) of FIG. 7.

FIG. 11

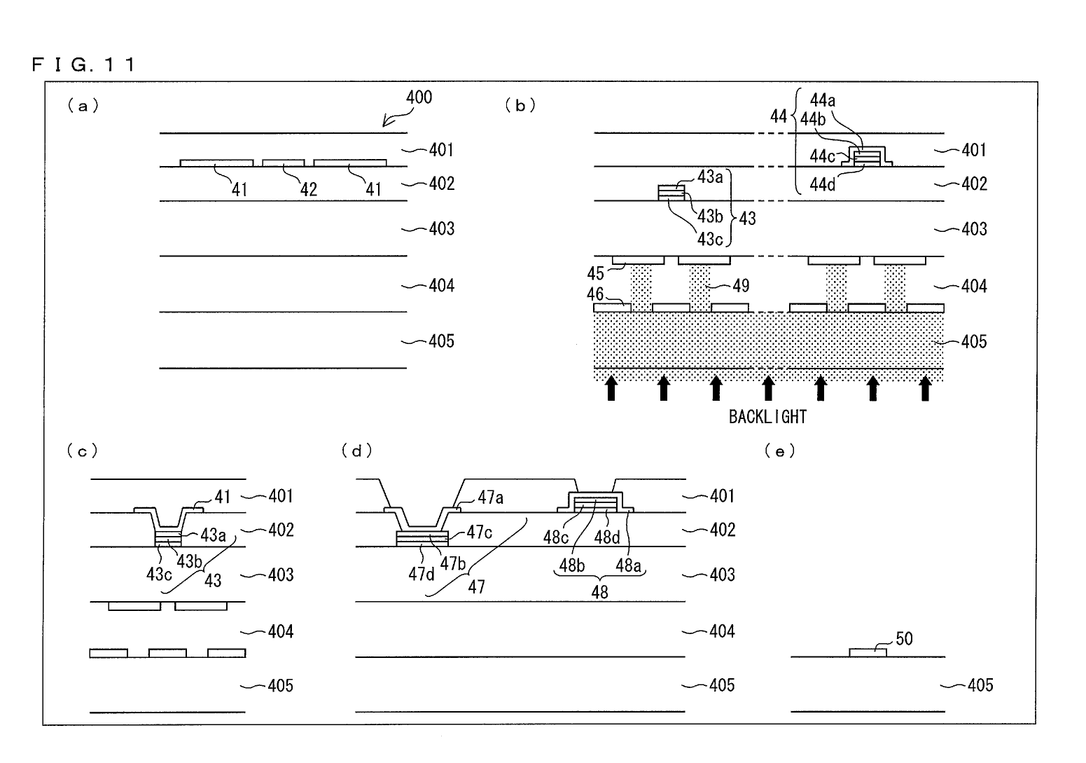

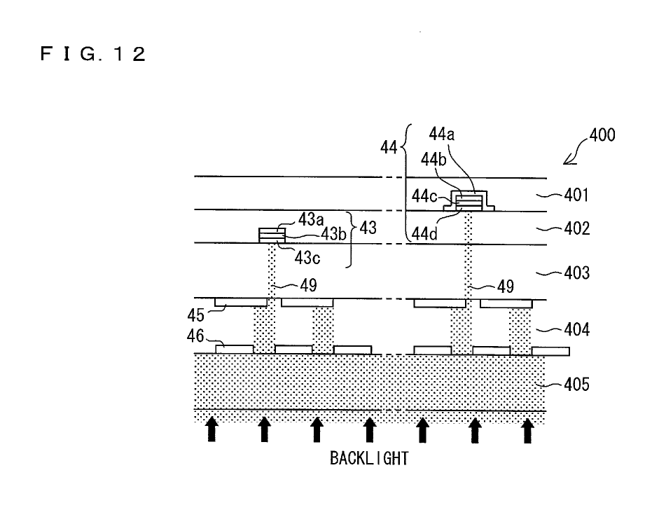

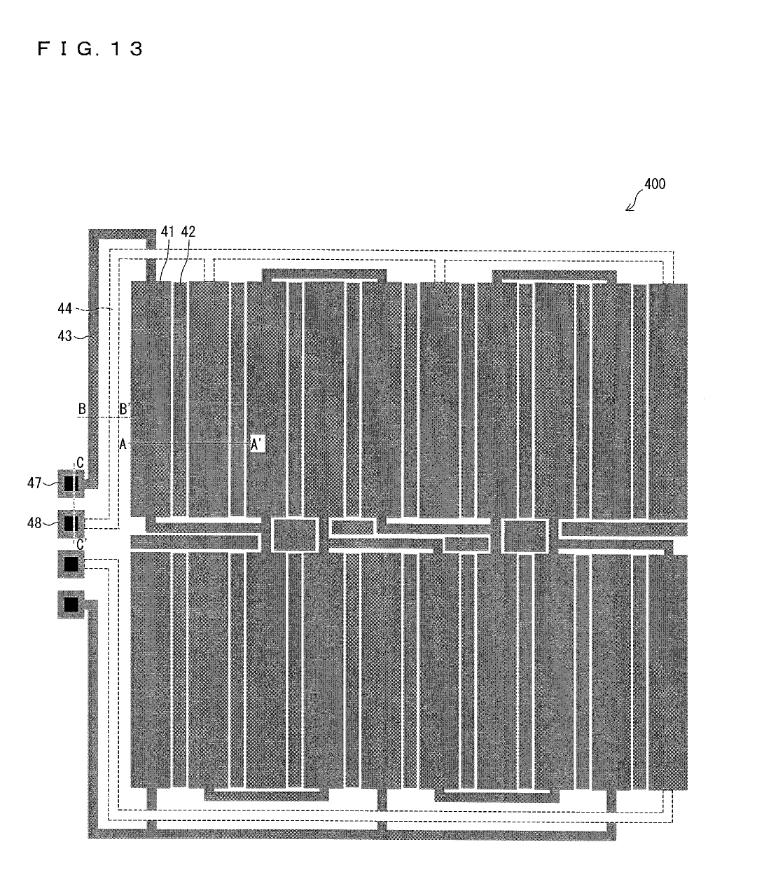

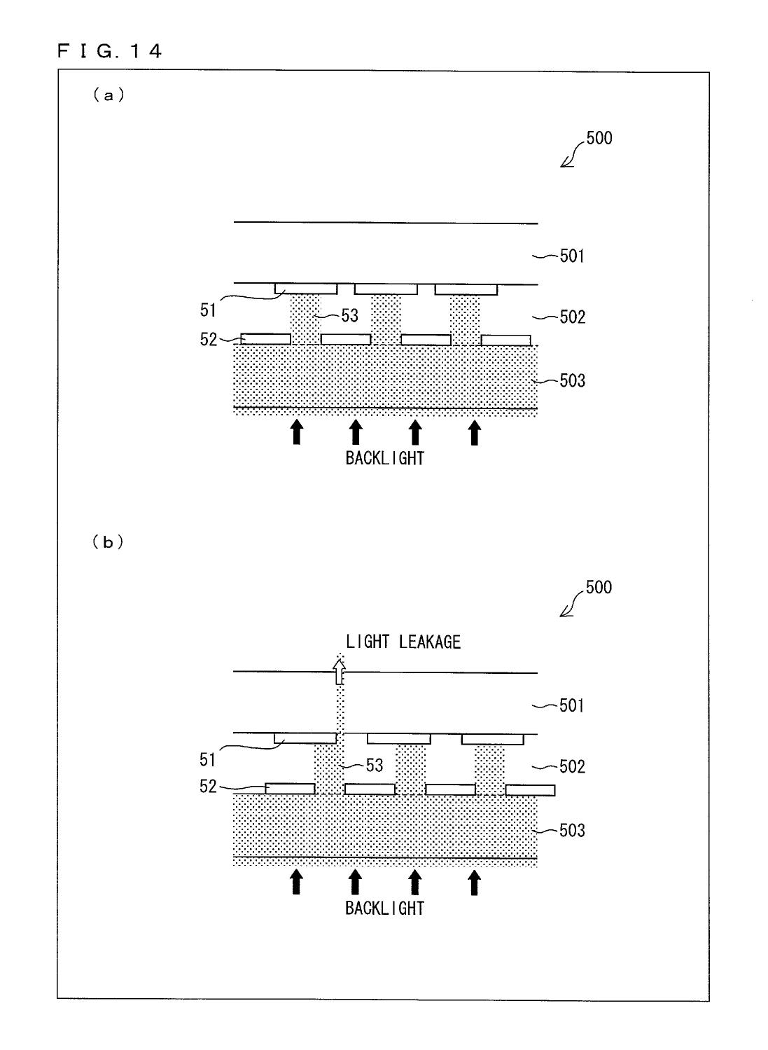

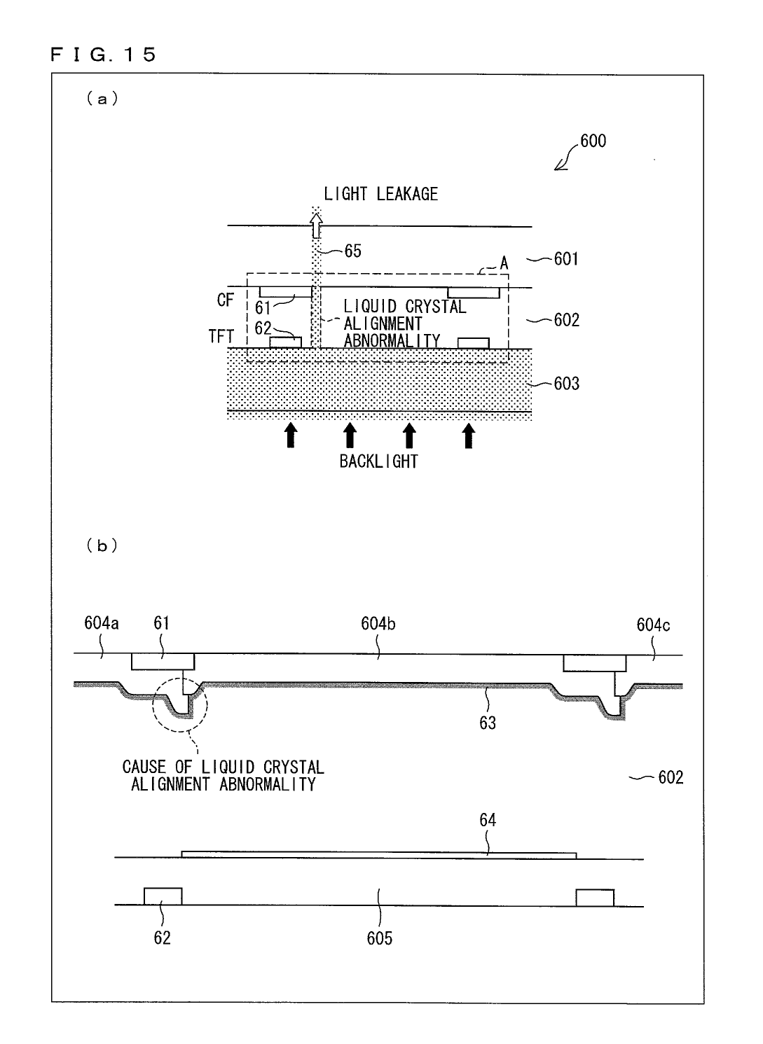

(a) of FIG. 11 is a cross-sectional view of a panel pixel section of a liquid crystal display device in accordance with a third embodiment of the present invention. (b) of FIG. 11 is a cross-sectional view of a panel peripheral part of the liquid crystal display device. (c) of FIG. 11 shows a part in which a touch electrode of the panel pixel section and a touch panel terminal of the panel peripheral part are connected. (d) of FIG. 11 is a cross-sectional view of a vicinity of the touch panel terminal of the liquid crystal display device. (e) of FIG. 11 is a cross-sectional view of a panel terminal section of the liquid crystal display device.

FIG. 12

FIG. 12 shows how the liquid crystal display device shown in each of (a) to (e) of FIG. 11 causes touch panel wires to prevent light leakage.

FIG. 13

FIG. 13 is a plan view of the liquid crystal display device shown in each of (a) to (e) of FIG. 11.

FIG. 14

Each of (a) and (b) of FIG. 14 is a cross-sectional view of a panel peripheral part of a conventional liquid crystal display device.

FIG. 15

(a) of FIG. 15 is a cross-sectional view of a panel pixel section of a conventional liquid crystal display device. (b) of FIG. 15 is an enlarged view of a region A in (a) of FIG. 15.

### DESCRIPTION OF EMBODIMENTS

### Embodiment 1

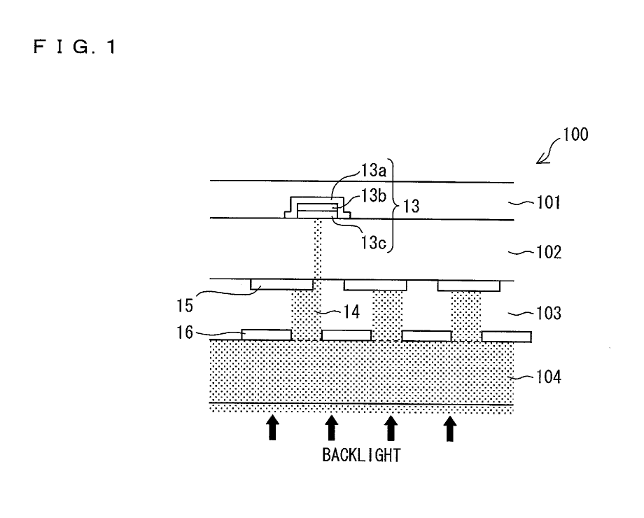

One embodiment of the present invention is described below with reference to FIG. 1 to FIG. 3.

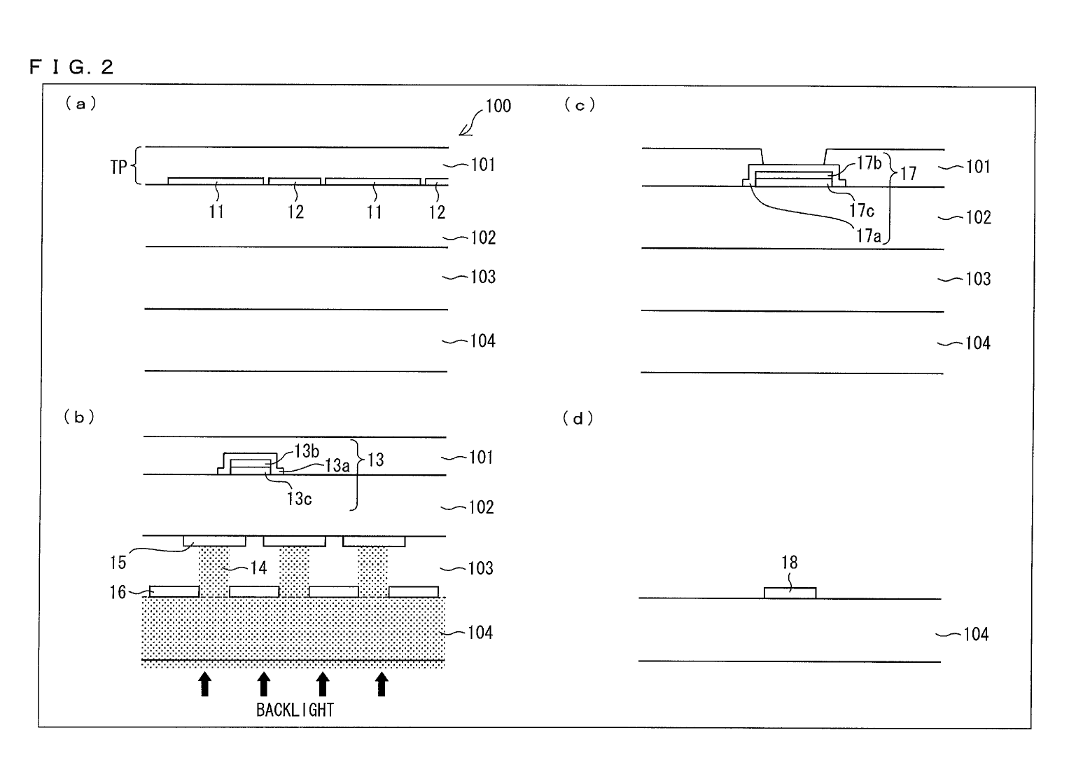

(a) of FIG. 2 is a cross-sectional view of a panel pixel section of a liquid crystal display device 100. (b) of FIG. 2 is a cross-sectional view of a panel peripheral part of the liquid crystal display device 100. The liquid crystal display device 100 includes a touch panel 101, a color filter substrate 102, a liquid crystal layer 103, and a back substrate 104 (see (a) and (b) of FIG. 2).

The touch panel 101 is a capacitive touch panel integrated with the liquid crystal display device 100 (in-cell touch panel incorporated in the liquid crystal display device 100). According to the present embodiment, the touch panel 101 has only one layer. Alternatively, the touch panel 101 may have a plurality of layers.

The touch panel 101 includes touch electrodes 11 and floating electrodes 12 in the panel pixel section (see (a) of FIG. 2).

The touch electrodes 11 are terminals made of ITO (Indium Tin Oxide) which is frequently used in a common liquid crystal display device as a conductive material having a transmittance of 90%. The floating electrodes 12 are terminals which are made of ITO and electrically isolated from an outside of the touch panel 101. In order to cause the entire touch panel 101 to look uniform, the floating electrodes 12 are provided so as to fill a gap between the respective touch electrodes 11.

The color filter substrate 102 is made of glass. In the panel peripheral part, the touch electrodes 11 and the floating electrodes 12 are provided on a surface (a first surface) of the color filter substrate 102 which surface faces the touch panel 101, and black matrixes 15 are provided on a surface (a second surface) of the color filter substrate 102 which surface is opposite from the surface (first surface).

The liquid crystal layer 103 is formed by filling a gap between the color filter substrate 102 and the back substrate 104 with TN (Twisted Nematic) liquid crystal.

The back substrate 104 is made of glass.

In the panel peripheral part, the color filter substrate 102 includes a touch panel wire 13 on a surface thereof which faces the touch panel 101, and includes the black matrixes 15 on a surface thereof that is opposite from the surface which faces the touch panel 101 (see (b) of FIG. 2). The back substrate 104 includes TFT wires 16 provided on a surface thereof which faces the color filter substrate 102.

Backlight comes from a lower part of the back substrate 104. The backlight, which passes thorough a gap between the respective TFT wires 16 as passing light 14, is blocked by the black matrixes 15.

The touch panel wire 13 has three layers: an ITO layer 13a, a light absorbing layer 13b, and an Al layer (a light blocking member, a wiring layer) 13c. In order to block light leaking from a gap between the respective black matrixes 15, the wire 13 is provided in the touch panel 101 so as to cover the gap between the respective black matrixes 15.

Note that strictly, in order to prevent light leakage without fail, the touch panel wire 13 is provided so as to partially overlap the black matrixes 15. That is, in order to block light which enters the color filter substrate from the second surface side and then leaks from a vicinity of the black matrixes 15 toward the touch panel 101, the touch panel wire 13 is provided on the touch panel 101 so that a part of the touch panel wire 13 and a part of the black matrixes 15 overlap each other.

Note here that the ITO layer 13a is made of ITO. The light absorbing layer 13b absorbing light, is made of a material which cannot easily reflect light, and is provided so as to prevent a deterioration in display quality due to reflection of light coming from an outside (the touch panel 101 side). The light absorbing layer 13b is made of a material of which the black matrixes 15 (described later) are made. The light absorbing layer 13b may be made of another material provided that the another material cannot easily reflect light. The Al layer 13c is made of aluminum that has a light blocking property, is easily subjected to an etching treatment, and is highly electroconductive. The light absorbing layer 13b is provided so as to cause a deterioration in display quality as described above. This is because aluminum of which the Al layer 13c is made has a high reflectance.

The black matrixes 15 are supposed to be black members each of which has a light blocking property, has a grid pattern, and is provided so as to cover a boundary between respective colors of respective color filters. The black matrixes 15 have a function of preventing a deterioration in contrast of a display image. However, the black matrixes 15 are also provided in the panel peripheral part as shown in (b) of FIG. 2, and have a function of blocking passing light 14 having passed though a gap between the respective TFT (Thin Film Transistor) wires 16.

The TFT wires 16 connect picture electrodes and TFTs, and are spread over the back substrate 104.

(c) of FIG. 2 is a cross-sectional view of a vicinity of a touch panel terminal 17 of the liquid crystal display device 100. The touch panel terminal 17 as shown in (c) of FIG. 2 is provided in an end part of the touch panel wire 13. The touch panel terminal 17 is an electrical connection point between the touch panel 101 and an outside, and has three layers: an ITO layer 17a, a light absorbing layer 17b, and an Al layer 17c. Note here that the ITO layer 17a is made of ITO, the light absorbing layer 17b is made of a material of which the black matrixes are made, and the Al layer 17c is made of aluminum.

(d) of FIG. 2 is a cross-sectional view of a panel terminal section of the liquid crystal display device 100. The panel terminal 18 serves as a part via which an image signal is supplied from an outside to the liquid crystal display device 100. The panel terminal 18 as shown in (d) of FIG. 2 is provided in an end part of each of the TFT wires 16.

FIG. 1 shows how the liquid crystal display device 100 causes the touch panel wire 13 to prevent light leakage. In FIG. 1, the passing light 14 that has passed through the gap between the respective TFT wires 16 further passes through the gap between the respective black matrixes 15, and is blocked by the touch panel wire 13.

As described above, even if a pattern is designed so that the black matrixes 15 are capable of blocking the passing light 14 having passed through the gap between the respective TFT wires 16, light leakage occurs when displacement occurs during combination of the color filter substrate 102 and the back substrate 104. However, the touch panel wire 13, which is provided so as to cover the gap between the respective black matrixes 15 as shown in FIG. 1, can block the passing light 14 having passed through the gap between the respective black matrixes 15 and the gap between the respective TFT wires 16.

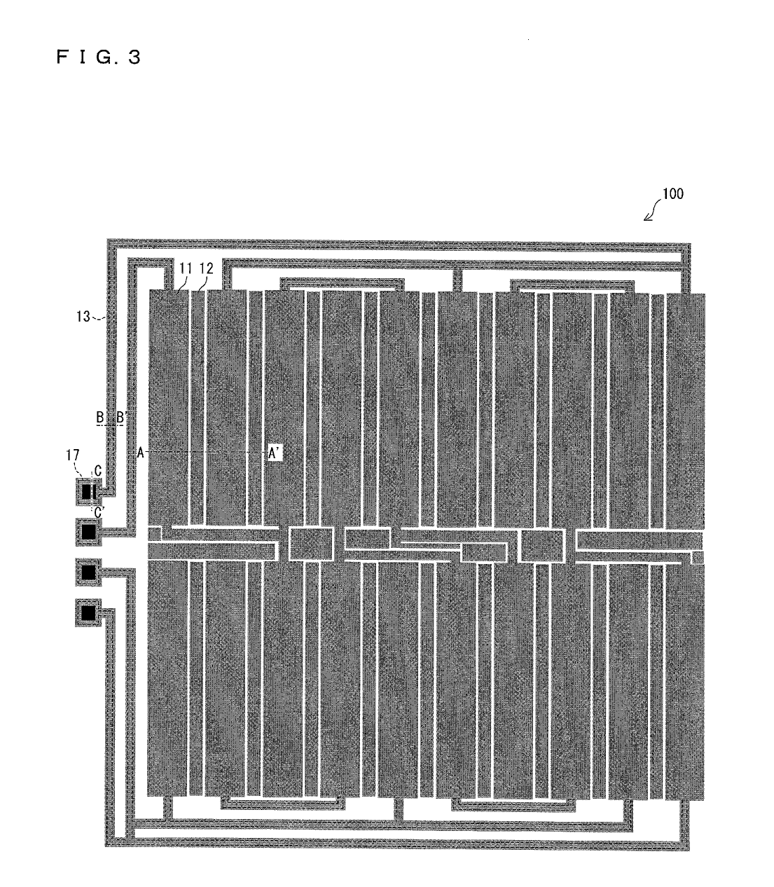

FIG. 3 is a plan view of the liquid crystal display device 100. Note that a cross-sectional view taken from line A-A′ of FIG. 3 corresponds to (a) of FIG. 2, a cross-sectional view taken from line B-B′ of FIG. 3 corresponds to (b) of FIG. 2, a cross-sectional view taken from line C-C′ of FIG. 3 corresponds to (c) of FIG. 2. The touch electrodes 11 and the touch panel terminal 17 are connected by the touch panel wire 13, and the touch-panel wire 13 is provided in a vicinity of a region in which the touch electrodes 11 and the floating electrodes 12 are provided (see FIG. 3).

### Embodiment 2

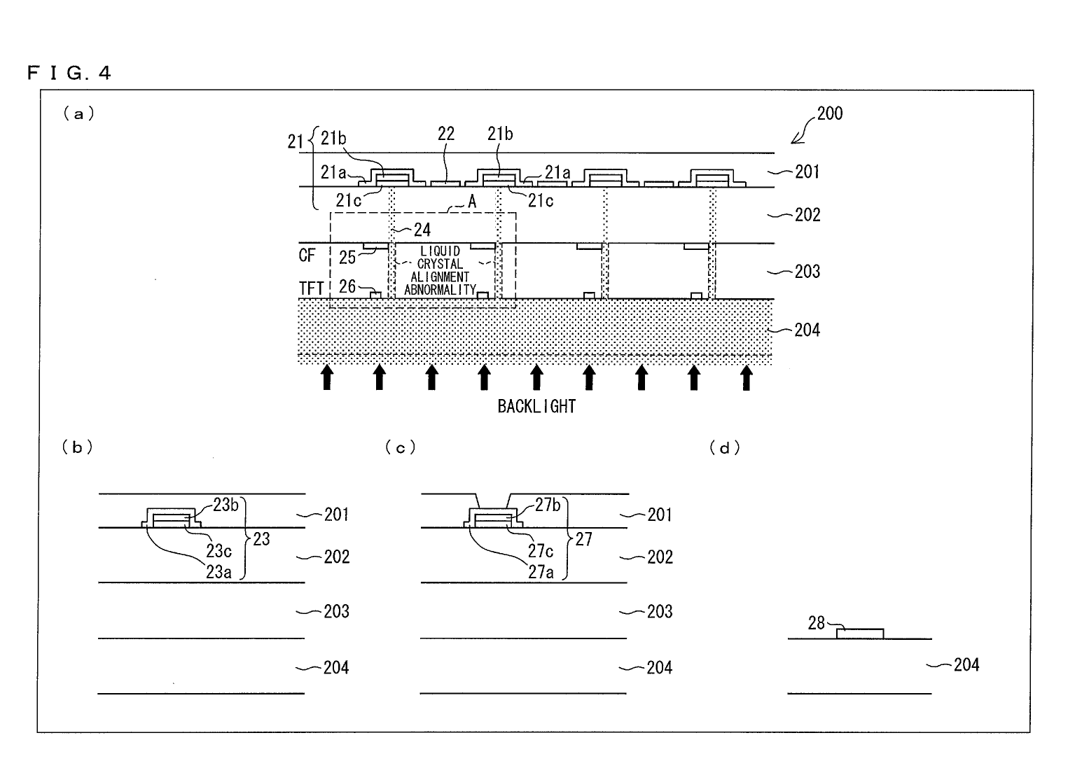

A second embodiment of the present invention is described below with reference to FIG. 4 to FIG. 6. Note that a description of members which are identical to those described in Embodiment 1 is to be omitted. The present embodiment discusses an arrangement for preventing light leakage from occurring in the panel pixel section.

(a) of FIG. 4 is a sectional view of a panel pixel section of a liquid crystal display device 200. The liquid crystal display device 200 includes a touch panel 201, a color filter substrate 202, a liquid crystal layer 203, and a back substrate 204 (see (a) of FIG. 4).

The touch panel 201 is a capacitive touch panel integrated with the liquid crystal display device 200 (in-cell touch panel incorporated in the liquid crystal display device 200) (see (a) of FIG. 4). According to the present embodiment, the touch panel 201 has only one layer. Alternatively, the touch panel 201 may have a plurality of layers.

The touch panel 201 includes touch electrodes 21 and floating electrodes 22 in the panel pixel section.

According to the color filter substrate 202, the touch electrodes 21 and the floating electrodes 22 are provided on a surface of the color filter substrate 202 which surface faces the touch panel 201, and color filters (described later) and black matrixes 25 are provided on a surface of the color filter substrate 202 which surface is opposite from the surface which faces the touch panel 201.

Each of the touch electrodes 21 has three layers: an ITO layer 21a, a light absorbing layer 21b, and an Al layer (a light blocking member, a wiring layer) 21c. Note here that the Al layer 21c is highly electroconductive and serves as a wire for transmitting an electric signal. Note that the touch electrodes 21 are provided above right edges of the respective black matrixes 25.

Note here that the ITO layer 21a is made of ITO, the light absorbing layer 21b is made of a material of which the black matrixes are made, and the Al layer 21c is made of aluminum.

Floating electrodes 22 are terminals which are made of ITO and electrically isolated from an outside of the touch panel 201. In order to cause the entire touch panel 201 to look uniform, the floating electrodes 22 are provided so as to fill a gap between the respective touch electrodes 21.

The liquid crystal layer 203 is formed by filling a gap between the color filter substrate 202 and the back substrate 204 with TN liquid crystal.

The back substrate 204 whose surface is provided with TFT wires 26 is made of glass.

(b) of FIG. 4 is a cross-sectional view of a panel peripheral part of the liquid crystal display device 200. The color filter substrate 202 includes a touch panel wire 23 provided on a surface thereof which faces the touch panel 201 (see (b) of FIG. 4). Since the touch panel wire 23 is exactly identical in arrangement to the touch panel wire 13 described in [Embodiment 1], a description thereof is omitted here.

(c) of FIG. 4 is a cross-sectional view of a vicinity of a touch panel terminal 27 of the liquid crystal display device 200. The touch panel terminal 27 as shown in (c) of FIG. 4 is provided in an end part of the touch panel wire 23. The touch panel terminal 27 is an electrical connection point between the touch panel 201 and an outside, and has three layers: an ITO layer 27a, a light absorbing layer 27b, and an Al layer 27c. Note here that the ITO layer 27a is made of ITO, the light absorbing layer 27b is made of a material of which the black matrixes are made, and the Al layer 27c is made of aluminum.

(d) of FIG. 4 is a cross-sectional view of a panel terminal section of the liquid crystal display device 200. The panel terminal 28 serves as a part via which an image signal is supplied from an outside to the liquid crystal display device 200. The panel terminal 28 as shown in (d) of FIG. 4 is provided in an end part of each of the TFT wires 26.

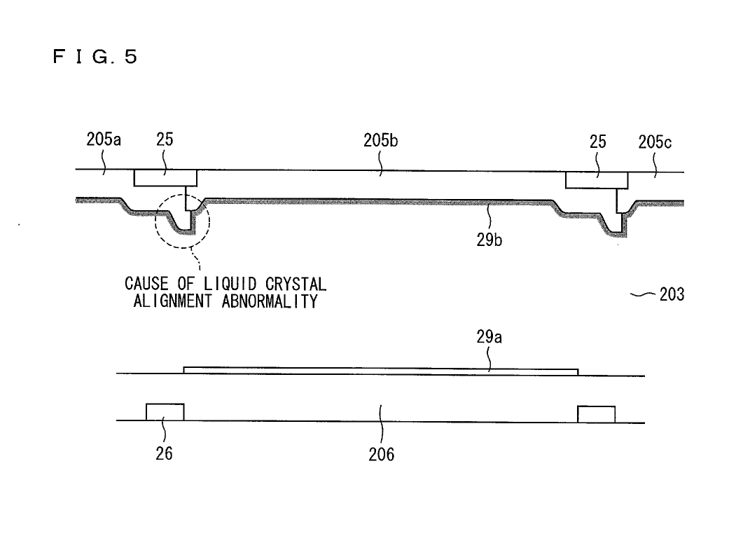

FIG. 5 is an enlarged view of a region A surrounded by a dotted line in (a) of FIG. 4.

Color filter substrates 205a, 205b, and 205c subjected to an etching treatment are provided on the color filter substrate 202 with no gap therebetween (see FIG. 5). A counter electrode 29b is provided on the color filters 205a, 205b, and 205c. The color filters 205a, 205b, and 205c differ in color.

Note that a pattern is designed so that a boundary between the color filters 205a and 205b and a boundary between the color filters 205b and 205c are deviated rightward from centers of respective line widths of the respective black matrixes 25.

The TFT wires 26 are covered with a protective film 206, and a pixel electrode 29a is provided on the protective film 206. An electric field for controlling a transmittance of the liquid crystal layer 203 is defined by the counter electrode 29b and the pixel electrode 29a.

Note here that displacement in patterning carried out during the etching treatment causes (i) the color filters 205a and 205b to overlap each other and (ii) the color filters 205b and 205c to overlap each other on the black matrixes 25, and protrusions are provided in respective parts in which (i) the color filters 205a and 205b overlap each other and (ii) the color filters 205b and 205c overlap each other. This causes an abnormality in alignment of liquid crystal in vicinities of the respective protrusions.

This causes light to be unexpectedly transmitted through a region in which such an alignment abnormality as described above occurs. Then, the passing light 24 is transmitted through the color filter substrate 202 as it is, and travels toward the touch panel 201 (see (a) of FIG. 4).

However, light leakage is prevented since the passing light 24 that has been transmitted through the color filter substrate 202 and then traveled toward the touch panel 201 is blocked by the touch electrodes 21 provided above the right edges of the respective black matrixes 25 (see (a) of FIG. 4).

Note that the protrusions occur on the black matrixes 25 so as to be deviated rightward without fail since a pattern is designed so that all the boundaries among the color filter 205a, 205b, and 205c are deviated rightward from centers of respective line widths of the respective black matrixes 25 (described above). Accordingly, in a case where the touch electrodes 21 are provided above the right edges of the respective black matrixes 25 as described above, i.e., in a case where parts of the respective touch electrodes 21 are provided so as to overlap parts of the respective black matrixes 25 which parts are located at the deviated boundaries among the color filter 205a, 205b, and 205c, the light leakage described above can be prevented.

Note that each of the protrusions may occur on the left side of a corresponding black matrix 25. In this case, the touch panel wire 23 should be provided above left edges of the respective black matrixes 25.

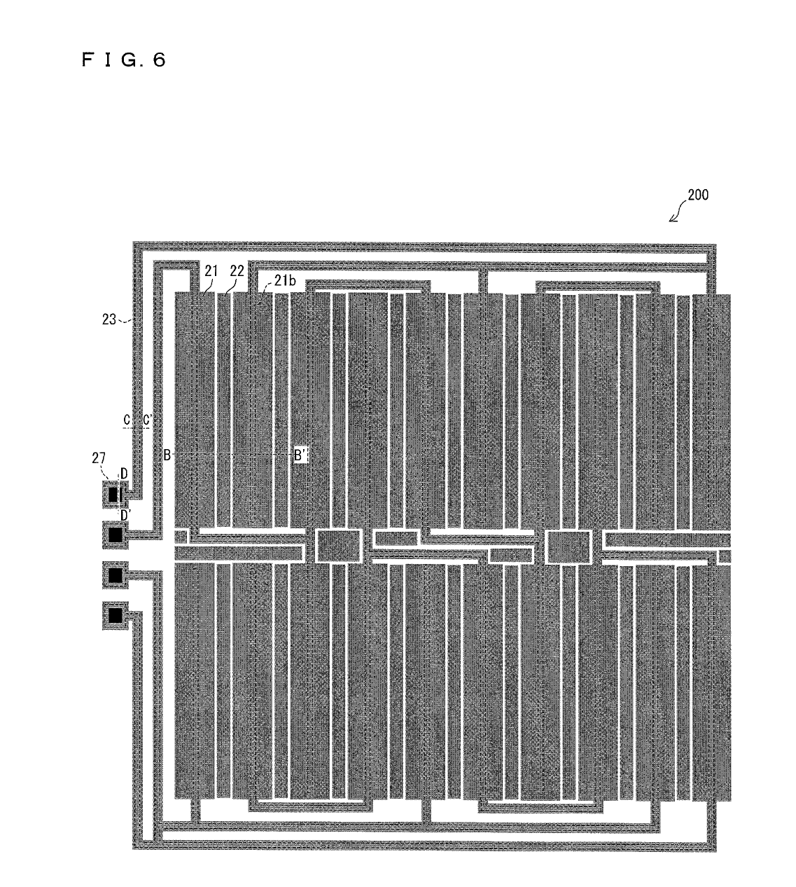

FIG. 6 is a plan view of the liquid crystal display device 200. Note that a cross-sectional view taken from line B-B′ of FIG. 6 corresponds to (a) of FIG. 4, a cross-sectional view taken from line C-C′ of FIG. 6 corresponds to (b) of FIG. 4, and a cross-sectional view taken from line D-D′ of FIG. 6 corresponds to (c) of FIG. 4.

The touch electrodes 21 and the touch panel terminal 27 are connected by the touch panel wire 23, and the touch panel wire 23 is provided in a vicinity of a region in which the touch electrodes 21 and the floating electrodes 22 are provided (see FIG. 6).

Note that the light absorbing layer 21b of each of the touch electrodes 21 is visible since the light absorbing layer 21b is transparent from the ITO layer 21a which is transparent. However, the light absorbing layer 21b, which is extremely thin, has no great influence on a display quality.

### Embodiment 3

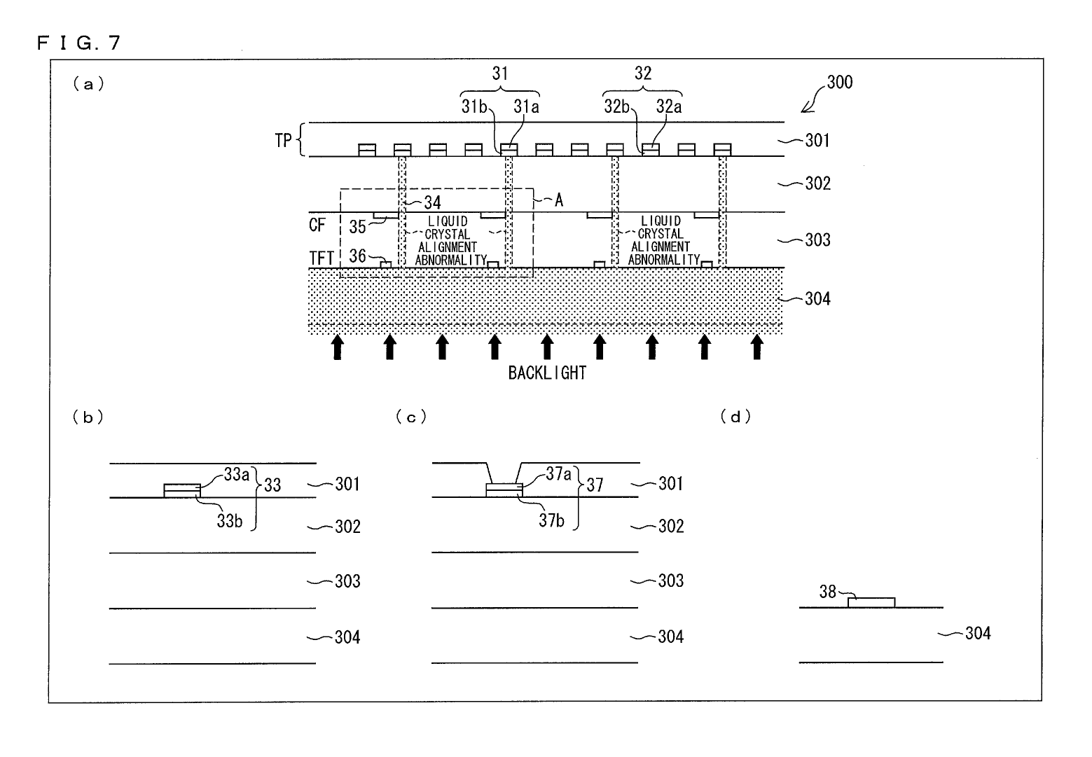

A third embodiment of the present invention is described below with reference to FIG. 7 to FIG. 10.

The present embodiment is arranged to cause touch electrodes 31 provided in a grid pattern prevent to prevent light leakage.

(a) of FIG. 7 is a cross-sectional view of a panel pixel section of a liquid crystal display device 300. The liquid crystal display device 300 includes a touch panel 301, a color filter substrate 302, a liquid crystal layer 303, and a back substrate 304 (see (a) of FIG. 7).

The touch panel 301 is a capacitive touch panel integrated with the liquid crystal display device 300 (in-cell touch panel incorporated in the liquid crystal display device 300) (see (a) of FIG. 7). According to the present embodiment, the touch panel 301 has only one layer. Alternatively, the touch panel 301 may have a plurality of layers.

The touch panel 301 includes touch electrodes 31 and floating electrodes 32 in the panel pixel section.

According to the color filter substrate 302, the touch electrodes 31 and the floating electrodes 32 are provided on a surface of the color filter substrate 302 which surface faces the touch panel 301, and color filters (described later) and black matrixes 35 are provided on a surface of the color filter substrate 302 which surface is opposite from the surface which faces the touch panel 301.

Each of the touch electrodes 31 has two layers: a light absorbing layer 31a and an Al layer (a light blocking member, a wiring layer) 31b. Note that the touch electrodes 31 are provided above right edges of the respective matrixes 35.

Note here that the light absorbing layer 31a is made of a material of which the black matrixes are made, and the Al layer 31b is made of aluminum.

The floating electrodes 32 are terminals that are electrically isolated from an outside of the touch panel 301. In order to cause the entire touch panel 301 to look uniform, the floating electrodes 32 are provided so as to fill a gap between the respective touch electrodes 31. As in the case of the touch electrodes 31, each of the floating electrodes 32 has two layers: a light absorbing layer 32a and an Al layer (a light blocking member, a wiring layer) 32b.

The liquid crystal layer 303 is formed by filling a gap between the color filter substrate 302 and the back substrate 304 with TN liquid crystal.

The back substrate 304 whose surface is provided with TFT wires 36 is made of glass.

(b) of FIG. 7 is a cross-sectional view of a panel peripheral part of the liquid crystal display device 300. The color filter substrate 302 includes a touch panel wire 33 provided on a surface thereof which faces the touch panel 301 (see (b) of FIG. 7). The touch panel wire 33 has two layers: a light absorbing layer 33a and an Al layer 33b. The light absorbing layer 33a is made of a material of which the black matrixes 35 are made, and the Al layer 33b is made of aluminum. Note that it is only necessary that the light absorbing layer 33a be made of a material which cannot easily reflect the light. The light absorbing layer 33a may be made of a material that is different from the material of which the black matrixes 35 are made.

(c) of FIG. 7 is a cross-sectional view of a vicinity of a touch panel terminal 37 of the liquid crystal display device 300. The touch panel terminal 37 as shown in (c) of FIG. 7 is provided in an end part of the touch panel wire 33. The touch-panel terminal 37 is an electrical connection point between the touch panel 301 and an outside, and has two layers: a light absorbing layer 37a and an Al layer 37b. Note here that the light absorbing layer 37a is made of a material of which the black matrixes 35 are made, and the Al layer 37b is made of aluminum.

(d) of FIG. 7 is a cross-sectional view of a panel terminal section of the liquid crystal display device 300. The panel terminal 38 serves as a part via which an image signal is supplied from an outside to the liquid crystal display device 300. The panel terminal 38 as shown in (d) of FIG. 7 is provided in an end part of each of the TFT wires 36.

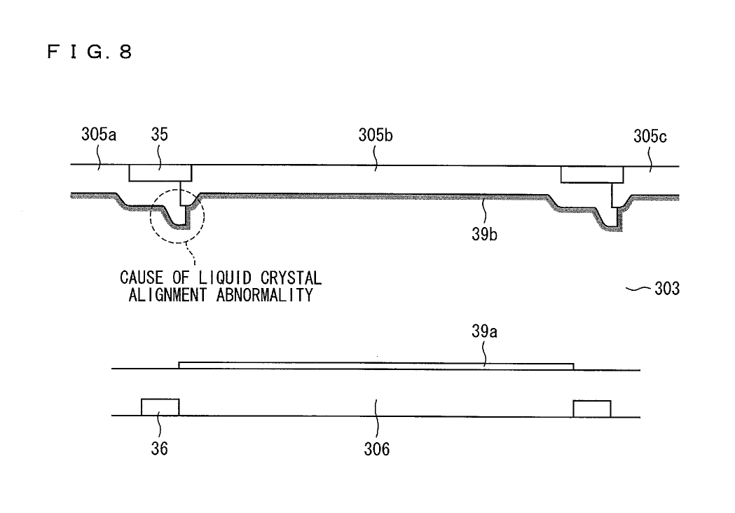

FIG. 8 is an enlarged view of a region A surrounded by a dotted line in (a) of FIG. 7.

Color filter substrates 305a, 305b, and 305c subjected to an etching treatment are provided on the color filter substrate 302 with no gap therebetween (see FIG. 8). A counter electrode 39b is provided on the color filters 305a, 305b, and 305c. The color filters 305a, 305b, and 305c differ in color.

Note that a pattern is designed so that a boundary between the color filters 305a and 305b and a boundary between the color filters 305b and 305c are deviated rightward on the respective black matrixes 25.

The TFT wires 36 are covered with a protective film 306, and a pixel electrode 39a is provided on the protective film 306. An electric field for controlling a transmittance of the liquid crystal layer 303 is defined by the counter electrode 39b and the pixel electrode 39a.

Note here that displacement in patterning carried out during the etching treatment causes (i) the color filters 305a and 305b to overlap each other and (ii) the color filters 604b and 604c to overlap each other on the black matrixes 35, and protrusions are in respective parts in which (i) the color filters 305a and 305b overlap each other and (ii) the color filters 305b and 305c overlap each other. This causes an abnormality in alignment of liquid crystal occurs in vicinities of the respective protrusions.

This causes light to be unexpectedly transmitted through a region in which such an alignment abnormality as described above occurs. Then, the passing light 34 is transmitted through the color filter substrate 302 as it is, and travels toward the touch panel 301 (see (a) of FIG. 7).

However, light leakage is prevented since the passing light 34 is blocked by the touch electrodes 31 provided above the right edges of the respective black matrixes 35 (see (a) of FIG. 7).

Note that the protrusions occur on the black matrixes 35 so as to be deviated rightward without fail since a pattern is designed so that the boundary between the color filters 305a and 305b and the boundary between the color filters 305b and 305c are deviated rightward on the respective black matrixes 35. Accordingly, in a case where the touch electrodes 31 are provided above the right edges of the respective black matrixes 35 as described above, the light leakage described above can be prevented.

Note that each of the protrusions may occur on the left side of a corresponding black matrix 35. That is, the color filters 305a and 305b may overlap each other on the left side of a corresponding black matrix 35, and the color filters 305b and 305c may overlap each other on the left side of a corresponding black matrix 35. In this case, the touch electrodes 31 should be provided above left edges of the respective black matrixes 35.

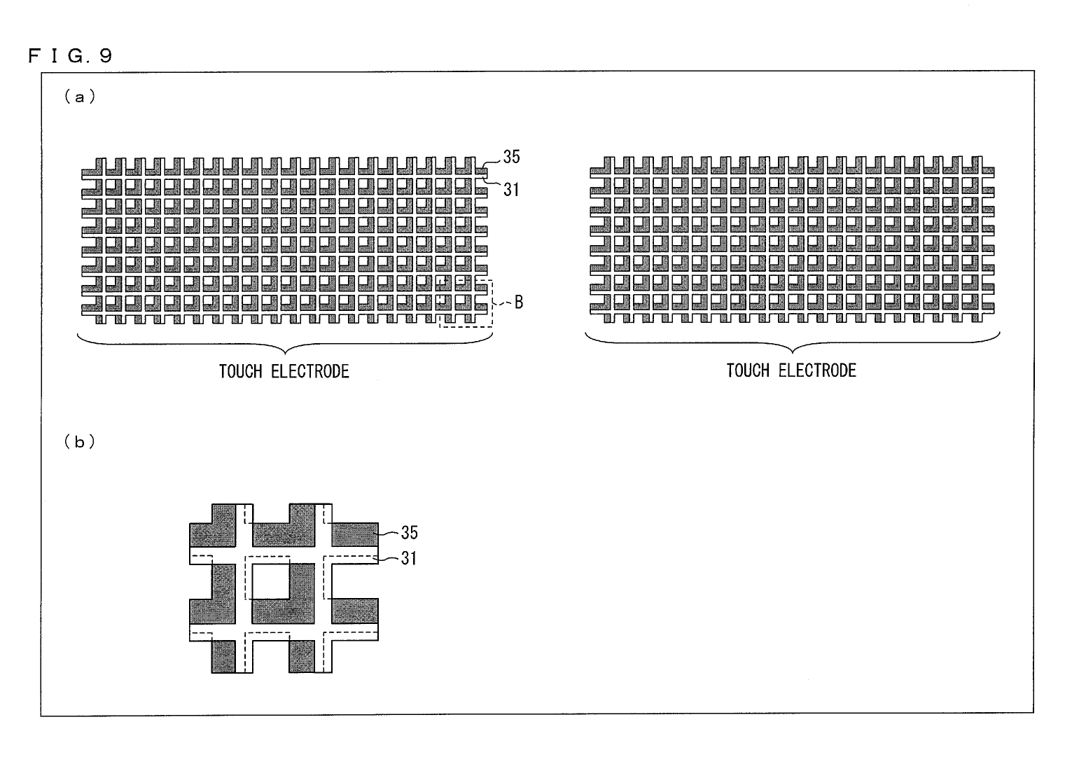

(a) of FIG. 9 is a plan view that shows a part of the touch electrodes 31. The touch electrodes 31 and the black matrixes 35 are provided in a grid pattern as shown in (a) of FIG. 9. Note that a floating electrode 32 (not illustrated) is provided between any touch electrodes 31 that are adjacent to each other in a horizontal direction.

(b) of FIG. 9 is an enlarged view of a region B that is surrounded by a dotted line in (a) of FIG. 9. The touch electrodes 31 partially overlap the black matrixes 35 as shown in (b) of FIG. 9.

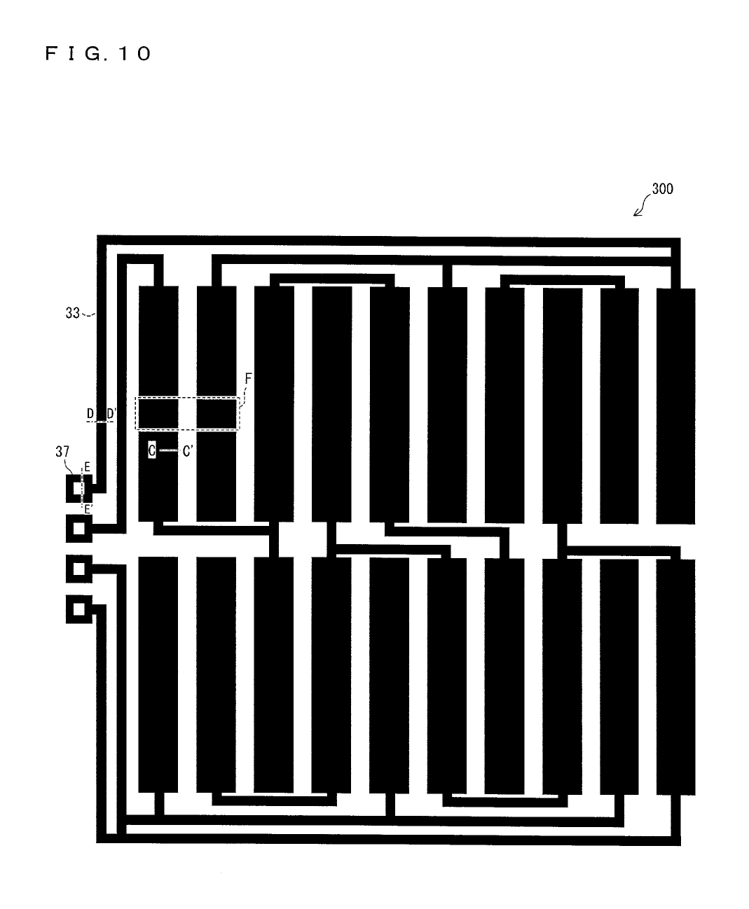

FIG. 10 is a plan view of the liquid crystal display device 300. Note that a cross-sectional view taken from line C-C′ of FIG. 10 corresponds to (a) of FIG. 7, a cross-sectional view taken from line D-D′ of FIG. 10 corresponds to (b) of FIG. 7, and a cross-sectional view taken from line E-E′ of FIG. 10 corresponds to (c) of FIG. 7. Note also that a region F surrounded by a dotted line is an area corresponding to (a) of FIG. 9.

The touch electrodes 31 and the touch panel terminal 37 are connected by the touch panel wire 33 as shown in FIG. 10, and the touch-panel wire 33 is provided in a vicinity of a region in which the touch electrodes 31 and the floating electrodes 32 are provided (see FIG. 10).

Note that the touch electrodes 31 are visible. However, the touch electrodes 31, each of which is extremely thin, have no influence on a display quality.

### Embodiment 4

A fourth embodiment of the present invention is described below with reference to FIG. 11 to FIG. 13. According to the present embodiment, in a panel peripheral part, two layers which are a touch panel and an interlayer insulating film (described later) (here, a touch panel and an interlayer insulating film are simply referred to “a touch panel”) and each of which has a touch panel wire that has a MoNb layer (a light blocking member, a wiring layer). Further, according to the present embodiment, a touch panel has a stacked structure in which two layers are stacked. However, the number of layers of the touch panel is not limited to two. Alternatively, the touch panel may have more layers.

An increase in number of touch panel terminals for enhancing a touch panel sensitivity also causes an increase in number of touch panel wires. It is effective to provide touch panel wires in two layers so as to spread many touch panel wires without much trouble within a limited space in the panel peripheral part.

(a) of FIG. 11 is a cross-sectional view of a panel pixel section of the liquid crystal display device 400. The liquid crystal display device 400 includes a touch panel 401, an interlayer insulating film (a touch panel) 402, a color filter substrate 403, a liquid crystal layer 404, and a back substrate 405 (see (a) of FIG. 11).

The touch panel 401 is a capacitive touch panel integrated with the liquid crystal display device 400 (in-cell touch panel incorporated in the liquid crystal display device 400).

The touch panel 401 includes touch electrodes 41 and floating electrodes 42 in the panel pixel section.

The interlayer insulating film 402 is provided so as to prevent an electric interference occurring between a touch panel signal and a data signal of a liquid crystal display image.

The color filter substrate 403 is made of glass. In the panel pixel section, the touch electrodes 41 and the floating electrodes 42 are provided on a surface of the interlayer insulating film 402 which surface faces the touch panel 401.

The liquid crystal layer 404 is formed by filling a gap between the color filter substrate 403 and the back substrate 405 with TN liquid crystal.

The back substrate 405 is made of glass.

(b) of FIG. 11 is a cross-sectional view of a panel peripheral part of the liquid crystal display device 400. The interlayer insulating film 402 includes a touch panel wire 44 provided on a surface thereof which faces the touch panel 401 (see (b) of FIG. 11).

The color filter substrate 403 includes (i) a touch panel wire 43 provided on a surface thereof which faces the interlayer insulating film 402 and (ii) black matrixes 45 provided on a surface thereof which faces the liquid crystal layer 404. The back substrate 405 includes TFT wires 46 provided on a surface thereof which faces the liquid crystal layer.

Backlight comes from a lower part of the back substrate 405. The backlight, which passes through a gap between the respective TFT wires 46 as passing light 49, is blocked by the black matrixes 45.

The touch panel wire 43 has three layers: a light absorbing layer 43a, a MoNb layer 43b, and an Al layer 43c. The touch panel wire 44 has four layers: an ITO layer 44a, a light absorbing layer 44b, a MoNb layer 44c, and an Al layer 44d. In order to block light leaking from a gap between the respective black matrixes 45, each of the touch panel wire 43 and the touch panel wire 44 is provided so as to cover the gap between the respective black matrixes 45. Note that strictly, in order to prevent light leakage without fail, the touch panel wire 43 and the touch panel wire 44 are provided so that at least one of the touch panel wire 43 and the touch panel wire 44 partially overlaps the black matrixes 45. In other words, the touch panel wire 43 partially overlaps and is also parallel to a substantially linear image that forms an image obtained by perpendicularly projecting the black matrixes 45 on the touch panel 401. Similarly, the touch panel wire 44 partially overlaps and is also parallel to a substantially linear image that forms an image obtained by perpendicularly projecting the black matrixes 45 on the touch panel 401.

Note here that the ITO layer 44a is made of ITO. The light absorbing layer 43a and the light absorbing layer 44b, each of which is made of a material of which the black matrixes 45 are made, may be made of another material provided that the another material cannot not easily reflect light. The MoNb layer (light blocking member, wiring layer) 43b and the MoNb layer (light blocking member, wire layer) 44c are made of MoNb that as in the case of aluminum described in [Embodiment 1], has a light blocking property, is easily subjected to the etching treatment, and is highly electroconductive. The Al layer 43c and the Al layer 44d are made of aluminum.

The black matrixes 45 have a function of blocking passing light 49 having passed through a gap between the respective TFT wires 46.

The TFT wires 46 connect picture electrodes and TFTs, and are spread over the back substrate 405.

(c) of FIG. 11 shows a part in which the touch electrodes 41 in the panel pixel section and the touch panel wire 43 in the panel peripheral section are connected. The touch panel wire 43, which is provided in a layer different from a layer on which the touch electrodes 41 are provided, is connected to the touch electrodes 41 provided along a hole provided above the touch panel wire 43 (see (c) of FIG. 11).

(d) of FIG. 11 is a cross-sectional view of a vicinity of a touch panel terminal 47 and a touch panel terminal 48 of the liquid crystal display device 400. The touch panel terminal 47 and the touch panel terminal 48 are provided in the panel peripheral section. The touch panel terminal 47 is provided on an end part of the touch panel wire 43, and the touch panel terminal 48 is provided on an end part of the touch panel wire 44.

Each of the touch panel terminal 47 and the touch panel terminal 48 is a point of an electrical connection with an outside. The touch panel terminal 47 has four layers: an ITO layer 47a, a light absorbing layer 47b, a MoNb layer 47c, and an Al layer 47d. The touch panel terminal 48 has four layers: an ITO layer 48a, a light absorbing layer 48b, a MoNb layer 47c, an Al layer 48d.

Note here that the ITO layer 47a and the ITO layer 48a are made of ITO, and the light absorbing layer 47b and the light absorbing layer 48b are made of a material of which the black matrixes are made. The MoNb layer 47c and the MoNb layer 48c are made of MoNb, and the Al layer 47d and the Al layer 48d are made of aluminum.

(e) of FIG. 11 is a cross-sectional view of a panel terminal section of the liquid crystal display device 400 in accordance with the present embodiment. The panel terminal 50 serves as a part via which an image signal is supplied from an outside to the liquid crystal display device 400. The panel terminal 50 as shown in (e) of FIG. 11 is provided in an end part of each of the TFT wires 46.

FIG. 12 shows how the liquid crystal display device 400 causes the touch panel wire 43 and the touch panel wire 44 to prevent light leakage. In FIG. 12, the passing light 49 that has passed through the gap between the respective TFT wires 46 further passes through the gap between the respective black matrixes 45, and is blocked by the touch panel wire 43 and the touch panel wire 44.

As described above, even if a pattern is designed so that the black matrixes 45 are capable of blocking the passing light 49 having passed through the gap between the respective TFT wires 46, light leakage occurs when displacement occurs during combination of the color filter substrate 403 and the back substrate 405. However, the touch panel wire 43 and the touch-panel wiring 44, each of which is provided so as to cover the gap between the respective black matrixes 45 as shown in FIG. 12, can block the passing light 14 having passed through each of the gap between the respective black matrixes 45 and the gap between the respective TFT wires 46.

FIG. 13 is a plan view of the liquid crystal display device 400. Note that a cross-sectional view taken from line A-A′ of FIG. 13 corresponds to (a) of FIG. 12, a cross-sectional view taken from line B-B′ of FIG. 13 corresponds to (b) of FIG. 12, a cross-sectional view taken from line C-C′ corresponds to (c) of FIG. 12. The touch panel electrodes 41 and the touch panel terminal 47 are connected by the touch panel wire 43, the touch panel electrodes 41 and the touch panel terminal 48 are connected by the touch panel wire 44, and the touch panel wire 43 and the touch panel wire 44 are provided in a vicinity of a region in which the touch electrodes 41 and the floating electrodes 42 are provided (see FIG. 3).

As described above, in order to attain the object, the liquid crystal display device in accordance with the present invention includes: a touch panel; and a color filter substrate having (i) a first surface which faces the touch panel and (ii) a second surface which is opposite from the first surface and on which at least one black matrix is provided, the touch panel including a light blocking member that has a light blocking property, and in order to block light which enters the color filter substrate from the second surface side and then leaks from a vicinity of the at least one black matrix toward the touch panel, the light blocking member being provided in the touch panel so that a part of the light blocking member and a part of the at least one black matrix overlap each other when the light blocking member is seen from the touch panel side.

In addition to the arrangement, the liquid crystal display device in accordance with the present invention is preferably arranged such that in a peripheral part of the liquid crystal display device, the light blocking member covers a gap between respective any two directly adjacent black matrixes of the at least one black matrix when seen from the touch panel side.

According to the arrangement, a gap between the respective any two adjacent black matrixes are covered with the light blocking member in the peripheral part of the liquid crystal display device.

Accordingly, light leakage from the touch panel can be prevented since the light blocking member blocks light which leaks from the gap of the respective any two black matrixes due to displacement having occurred during combination of a TFT substrate and the color filter substrate.

In addition to the arrangement, the liquid crystal display device in accordance with the present invention is preferably arranged such that: in a pixel section of the liquid crystal display device, a boundary between two color filters which have different colors is located so as to be deviated in a given direction from a center of a line width of the at least one black matrix; and when seen from the touch panel side, the part of the light blocking member overlaps the part of the at least one black matrix that is located in the given direction in which the boundary between the two color filters is deviated.

According to the arrangement, the part of the light blocking member overlaps the part of the at least one black matrix that is located in the given direction in which the boundary between the two color filters is deviated.

Accordingly, even if the two color filters that have two different colors are displaced at the boundary therebetween and overlap each other to form a protrusion, and if an abnormality in alignment of liquid crystal which abnormality occurs in a vicinity of the protrusion causes light to be transmitted through a liquid crystal layer, light leakage from the touch panel can be prevented since the light blocking member blocks the light.

In addition to the arrangement, the liquid crystal display device in accordance with the present invention is preferably arranged such that the touch panel has a stacked structure in which a plurality of layers are stacked, and each of at least two layers of the plurality of layers has the light blocking member.

According to the arrangement, in a case the touch panel has the stacked structure in which the plurality of layers are stacked, the light blocking member can be provided in each of the plurality layers which are different from each other. This can prevent light leakage from the touch panel more effectively.

In addition to the arrangement, the liquid crystal display device in accordance with the present invention is preferably arranged such that the light blocking member has (i) a first surface which faces the color filter substrate and (ii) a second surface which is opposite from the first surface and on which a light absorbing layer is provided.

In a case where light having entered a screen of the liquid crystal display device from an outside is reflected in the liquid crystal display device, the screen look white. This causes a deterioration in display quality.

According to the arrangement, even if external light has entered the liquid crystal display device from the touch panel side, light which enters the light blocking member from an opposite side from the color filter substrate side, i.e., from an outside of the liquid crystal display device is not reflected but is absorbed by a surface of the light blocking member.

This is because the light shielding member has the light absorbing layer on the second surface opposite from the first surface that faces the color filter substrate.

This makes it possible to prevent a deterioration in display quality of the liquid crystal display device.

In addition to the arrangement, the liquid crystal display device in accordance with the present invention is preferably arranged such that the light blocking member is a wiring layer which is provided in the touch panel.

According to the arrangement, the liquid crystal display device can use, as the light blocking member, the wiring layer provided in the touch panel. This can prevent light leakage from the touch panel without the need of adding an arrangement to a conventional touch panel.

This makes it possible to prevent an increase in cost of producing a liquid crystal display.

The present invention is not limited to the descriptions of the respective embodiments, but may be variously altered within the scope of the claims. That is, an embodiment derived from a proper combination of technical means appropriately altered within the scope of the claims is encompassed in the technical scope of the invention.

### INDUSTRIAL APPLICABILITY

The present invention can be used for a liquid crystal panel which is provided with an in-cell capacitive touch panel.

### REFERENCE SIGNS LIST

| | |
|---|---|
| 100, 200, 300, 400 | Liquid Crystal Display Panel |
| 101, 201, 301, 401 | Touch Panel |
| 402 | Interlayer Insulating Film |
| | (Touch Panel) |
| 13c, 21c, 31b | Al layer (Light Blocking |
| | Member, Wiring Layer) |
| 43c, 44c | MoNb layer (Light Blocking |
| | Member, Wiring Layer) |
| 15, 25, 35, 45 | Black Matrix |
| 102, 202, 303, 403 | Color Filter Substrate |
| 13b, 23b, 33b, 43b, 44b | Light Absorbing Layer |
| 205a, 205b, 205c, 205d, 305a, 305b, 305c | Color Filter |

1: A liquid crystal display device comprising:
a touch panel; and
a color filter substrate having (i) a first surface which faces the touch panel and (ii) a second surface which is opposite from the first surface and on which at least one black matrix are provided,
the touch panel including a light blocking member that has a light blocking property, and
in order to block light which enters the color filter substrate from the second surface side and then leaks from a vicinity of the at least one black matrix toward the touch panel, the light blocking member being provided in the touch panel so that a part of the light blocking member and a part of the at least one black matrix overlap each other when the light blocking member is seen from the touch panel side.

2: The liquid crystal display device according to claim 1, wherein in a peripheral part of the liquid crystal display device, the light blocking member covers a gap between respective any two directly adjacent black matrixes of the at least one black matrix when seen from the touch panel side.

3: The liquid crystal display device according to claim 1, wherein:
in a pixel section of the liquid crystal display device,
a boundary between two color filters which have different colors is located so as to be deviated in a given direction from a center of a line width of the at least one black matrix; and
when seen from the touch panel side, the part of the light blocking member overlaps the part of the at least one black matrix that is located in the given direction in which the boundary between the two color filters is deviated.

4: The liquid crystal display device according to claim 1, wherein the touch panel has a stacked structure in which a plurality of layers are stacked, and each of at least two layers of the plurality of layers has the light blocking member.

5: The liquid crystal display device according to claim 1, wherein the light blocking member has (i) a first surface which faces the color filter substrate and (ii) a second surface which is opposite from the first surface and on which a light absorbing layer is provided.

6: The liquid crystal display device according to claim 1, wherein the light blocking member is a wiring layer which is provided in the touch panel.
